(19) United States
(12) Patent Application Publication
(10) Pub. No.: US 2022/0187802 A1
(43) Pub. Date: Jun. 16, 2022

(54) METHOD AND SYSTEM FOR DETECTING MANUFACTURING PROCESS BREACHES IN MANUFACTURING OF THREE-DIMENSIONAL PARTS

(71) Applicant: VIACCESS, COURBEVOIE (FR)

(72) Inventors: Alice WITTENBERG, ROSH HA'AYIN (IL); Pérez PELAGE, MEDAN (FR); Alain NOCHIMOWSKI, RAANANA (IL); Thierry LELÉGARD, PARIS (FR); Dan GHITA, RUEIL MALMAISON (FR); Hadrien FLAMMANG, PARIS (FR); Dror COHEN, Moshav Beit Hanan (IL)

(21) Appl. No.: 17/310,446

(22) PCT Filed: Apr. 2, 2019
(86) PCT No.: PCT/IB2019/000952

§ 371 Date: Aug. 3, 2021

(30) Foreign Application Priority Data
Feb. 7, 2019 (FR) 19 01209

(51) Int. Cl. G05B 19/418; H04L 9/34; G06Q 50/04

(52) U.S. Cl. CPC G05B 19/4188; G05B 2219/36542; G06Q 50/04; H04L 9/34

(57) ABSTRACT

The invention concerns a method and system for manufacturing a three-dimensional part by a computer-aided manufacturing process, and an associated method and system for detecting a manufacturing process breach in a computer-aided manufacturing process of a three-dimensional part.

The three-dimensional part manufacturing comprises computing pedigree information (10) relating to the manufacturing process of the three-dimensional part, wherein the pedigree information (10) gives access to pedigree data of the manufacturing process of the three-dimensional part, the pedigree data comprising manufacturing data (8D) collected during the manufacturing process of the three-dimensional part, and inserting a mark (20) encoding the pedigree information on a surface or within a volume of the three-dimensional part, to obtain a marked three-dimensional part (24).

The detection of manufacturing process breach comprises pedigree data (42) retrieval from a marked three-dimensional part and determining whether a manufacturing breach occurred by applying classifying means to the retrieved pedigree data.

The present invention concerns a method and system for manufacturing a three-dimensional part by computer aided manufacturing. The invention also concerns a method and system for detecting a manufacturing process breach in a computer-aided manufacturing process of a marked three-dimensional part.

The invention belongs to the field of three-dimensional (3D) parts computer aided manufacturing security.

Computer-aided manufacturing of 3D parts comprises, on the one hand, additive manufacturing in which a 3D part is manufactured by depositing successive layers of predetermined materials in accordance with a model of the 3D part obtained by computer aided design (CAD). The additive manufacturing includes for example <<Selective Laser Melting>> (SLM), in which a laser beam is directed towards a powder bed, or <<Directed Energy Deposition>> (DED), in which a laser beam is directed towards materials to be melted and deposited by layers. On the other hand, computer-aided manufacturing includes subtractive manufacturing, comprising machining, injection molding, assembly, which relies upon computer aided design.

In all computer-aided manufacturing processes, input manufacturing data is provided, including the model of the 3D part, the materials to be used and their properties, and various functioning parameters of the manufacturing machine. Furthermore, during the actual manufacturing of a 3D part, data relating to the actual manufacturing can be collected, such as: manufacturing conditions related data (e.g. date, location, machine type), and sensor-captured manufacturing parameters. Data relating to the actual manufacturing may be common to several 3D parts jointly manufactured, within a single tray since such parts share their manufacturing. The pedigree of a 3D part comprises at least part of the data relating to the actual manufacturing.

In some practical applications, for example forensic applications, insurance against counterfeiting, or more generally security assessment, it is important to be able to guarantee the pedigree of a 3D part. Moreover, legal obligation may exist of such guarantee for a given duration, such as (ten years) in automotive industry, or (thirty years) in aerospace industry.

It is an object of the invention to improve the security of computer-aided manufacturing of 3D parts.

To that end, the invention concerns a computer-aided manufacturing process of a three-dimensional part, the three-dimensional part being manufactured by a manufacturing system based on input manufacturing data comprising a model of the three-dimensional part, input manufacturing data related to a required material and its required characteristics, and input parameters relative to the manufacturing system, comprising:
computing pedigree information relating to the manufacturing process of the three-dimensional part, wherein the pedigree information gives access to pedigree data of the three-dimensional part, the pedigree data comprising manufacturing data collected during the manufacturing process of the three-dimensional part,
inserting a mark encoding the pedigree information on a surface or within a volume of the three-dimensional part, to obtain a marked three-dimensional part.

Advantageously, the invention provides for non-tamperable pedigree association to a 3D part. Therefore, it is possible to certify the 3D part's manufacturing conditions.

Furthermore, post production manufacturing process security assessment may be conducted based on the pedigree data retrieved.

The method of the invention further comprises features as recited below, taken independently or according to any combination which is technically acceptable.

The pedigree data further comprises input manufacturing data of the three-dimensional part.

The computing of pedigree information comprises:
computing a unique identifier of the three-dimensional part,
obtaining a pedigree data indication comprising the pedigree data of the three-dimensional part or providing access to a storage address of the pedigree data of the three-dimensional part,
applying a cryptographic combination of said unique identifier and said pedigree data indication to obtain the pedigree information.

The step of computing a unique identifier of the three-dimensional part comprises computing a physically unclonable function of the three-dimensional part.

The step of computing a unique identifier further comprises applying a cryptographic function to the physically unclonable function of the three-dimensional part.

Applying a cryptographic combination of said unique identifier and said pedigree data indication comprises applying a secret key cryptographic function to the pedigree data indication, wherein the used secret key is said unique identifier.

The inserting of a mark is achieved by printing said mark, as a whole or piece by piece, on a surface or within an internal volume of the three-dimensional part.

According to another aspect, the invention concerns a system for manufacturing a three-dimensional part according to a computer-aided manufacturing process, the three-dimensional part being manufactured by a manufacturing system based on input manufacturing data comprising a model of the three-dimensional part, input manufacturing data related to a required material and its required characteristics, and input parameters relative to the manufacturing system, the system comprising:
a module configured to compute pedigree information relating to the three-dimensional part, wherein the pedigree information gives access to pedigree data of the three-dimensional part, the pedigree data comprising manufacturing data collected during the manufacturing process of the three-dimensional part,
a module configured to insert a mark encoding the pedigree information on a surface or within a volume of the three-dimensional part, to obtain a marked three-dimensional part.

According to another aspect, the invention concerns a method for detecting a manufacturing process breach in a computer-aided manufacturing process of a marked three-dimensional part, the marked three-dimensional part being manufactured according to a computer-aided manufacturing process, the marked three-dimensional part being manufactured by a manufacturing system based on input manufacturing data comprising a model of the three-dimensional part, input manufacturing data related to a required material and its required characteristics, and input parameters relative to the manufacturing system. The method comprises:
generating classifying means for manufacturing process breach detection,
retrieving the marked three-dimensional part's pedigree data, the retrieval comprising:
   reading a mark of the marked three-dimensional part, the mark encoding pedigree information, wherein the pedigree information gives access to pedigree data of the marked three-dimensional part, the pedigree data comprising manufacturing data collected during the manufacturing process of the marked three-dimensional part,
   retrieving the pedigree data of the marked three-dimensional part using said pedigree information,
determining whether a manufacturing process breach of the marked three-dimensional part's manufacturing process occurred, by applying the classifying means to the retrieved pedigree data.

The method for detecting a manufacturing process breach in a computer-aided manufacturing process of a marked three-dimensional part comprises features as recited below, taken independently or according to any combination which is technically acceptable.

The retrieving of the pedigree data comprises:
computing a unique identifier of the marked three-dimensional part,
applying a cryptographic recombination of said unique identifier and said pedigree information to obtain a pedigree data indication associated to the marked three-dimensional part;
obtaining pedigree data of the marked three-dimensional part from the pedigree data indication.

The cryptographic recombination of said unique identifier and said pedigree information comprises applying a secret key cryptographic function to the pedigree information, wherein the secret key is said unique identifier.

Generating classifying means for manufacturing process breach detection comprises applying to a plurality of pedigrees forming a training data set:
labeling each of the pedigrees of the plurality of pedigrees forming the training data set with an identifier of its expected class;
training a machine learning algorithm with the training data set to obtain a classifying means, comprising a list of parameter values characterizing classes of pedigrees, and to be applied to three-dimensional marked parts pedigrees for detecting breaches in the manufacturing processes of said three-dimensional marked parts pedigrees;
storing the obtained classifying means.

The labeling of each pedigree of the plurality of pedigrees forming the training data set comprises:
applying, to the plurality of pedigrees forming the training data set, an anomaly detection artificial intelligence algorithm to identify outliers and inliers among the plurality of pedigrees forming the training data set;
computing a score of anomaly extent associated to each of the identified outliers and inliers,
classifying each pedigree of the plurality of pedigrees forming the training data set into classes based on its score of anomaly extent.

The method further comprises raising an alarm in case of manufacturing process breach detection.

The method further comprises, in case of manufacturing process breach detection:
retrieving an additional pedigree within the same class as that of the retrieved pedigree data;
identifying an additional marked three-dimensional part the pedigree of which is the retrieved additional pedigree;
securely verifying the additional pedigree data actually is the additional marked three-dimensional part's pedigree data, comprising retrieving its pedigree data from the additional marked three-dimensional part.

According to another aspect, the invention concerns a system for detecting a manufacturing process breach in a computer-aided manufacturing process of a marked three-dimensional part, the marked three-dimensional part being manufactured according to a computer-aided manufacturing process, the marked three-dimensional part being manufactured by a manufacturing system based on input manufacturing data comprising a model of the three-dimensional part, input manufacturing data related to a required material and its required characteristics, and input parameters relative to the manufacturing system, comprising least one processor configured to implement:
a module configured to generate classifying means for manufacturing process breach detection,
modules configured to retrieve the marked three-dimensional part's pedigree data, the retrieval comprising:
   reading a mark of the marked three-dimensional part, the mark encoding pedigree information, wherein the pedigree information gives access to pedigree data of the marked three-dimensional part, the pedigree data comprising manufacturing data collected during the manufacturing process of the marked three-dimensional part,
   retrieving the pedigree data of the marked three-dimensional part using said pedigree information,
a module configured to determine, whether a manufacturing process breach of the marked three dimensional part's manufacturing process occurred, by applying the classifying means to the retrieved pedigree data.

The invention will be better understood in the light of the detailed description and accompanying drawings listed below, which are only exemplary and by no way limiting:

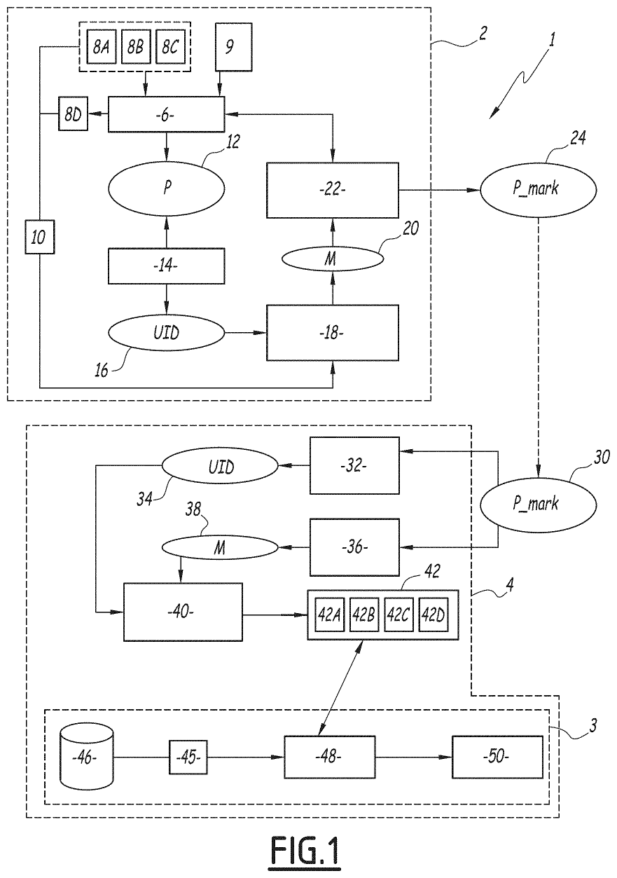

FIG. 1 schematically represents a system for manufacturing a 3D part and for manufacturing process breach detection;

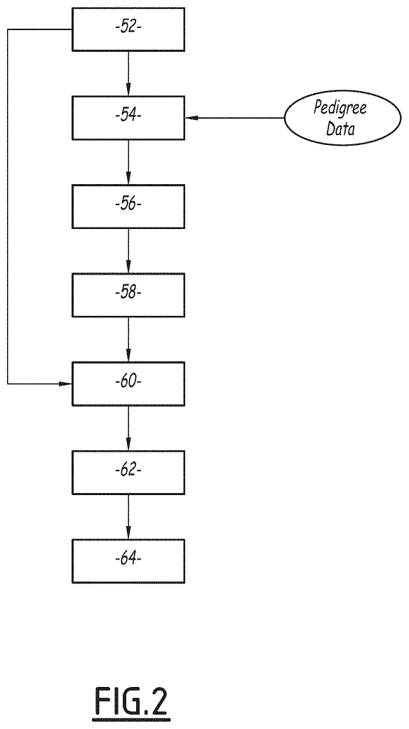

FIG. 2 is a block diagram of an embodiment of a method for manufacturing a 3D part;

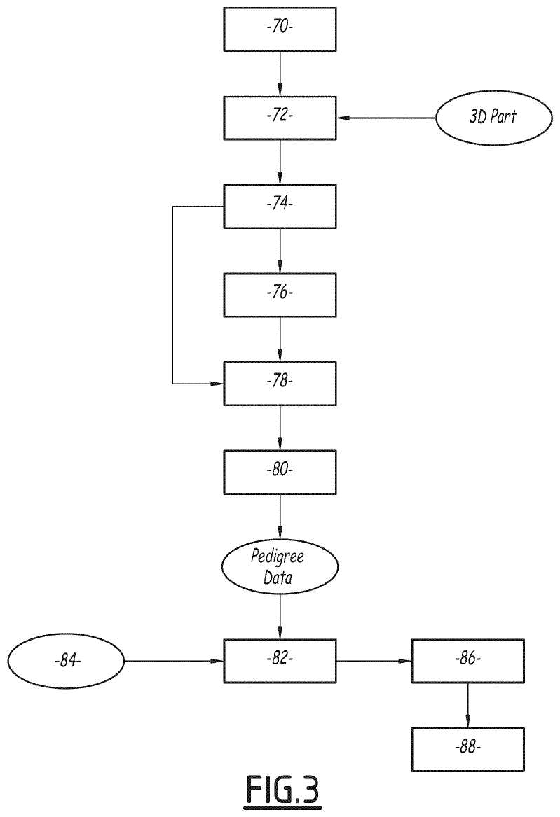

FIG. 3 is a block diagram of an embodiment of a method for manufacturing process breach detection;

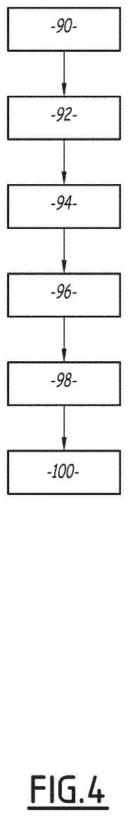

FIG. 4 is a block diagram of the main steps of a method of generating classifying means according to an embodiment.

FIG. 1 shows a schematic view of a system 1 for manufacturing a three-dimensional (3D) part, and detecting a manufacturing process breach, according to an embodiment of the invention.

The manufacturing process breach detection relies on the pedigree of a 3D part, as explained in detail below. The pedigree comprises data including at least data relating to the actual manufacturing of the 3D part.

A manufacturing process breach may be detected by analysing a pedigree in which one or several manufacturing actual parameters or steps differ from homologous nominal parameters or steps which are expected to provide one or more copies of a specified 3D part, said pedigree thus being said unexpected.

In the embodiment illustrated, the system 1 comprises a first subsystem 2 for manufacturing a 3D part, configured to insert a mark into a manufactured 3D part to obtain a marked 3D part P_mark, and a second subsystem 4 for manufacturing process breach detection configured to read the mark from a marked 3D part, then to retrieve on this basis, and analyse, the marked 3D part's pedigree, and finally raise a security alarm if that analysis shows a breach might have occurred during the marked 3D part's manufacturing. The mark either comprises or gives access to pedigree data associated to the 3D part.

In the embodiment illustrated, the pedigree data is used for detecting a manufacturing process breach, and raising a security alarm following the detection. An unexpected marked 3D part pedigree may be due to a breach of security of the marked 3D part's manufacturing process. Such a breach may be caused by an attack against the manufacturing process security or manufacturing system's security during the marked 3D part's manufacturing.

In an embodiment, when a marked 3D part manufacturing process breach is detected, at least one supplementary marked 3D part with similarly breached manufacturing process is obtained.

The first subsystem 2 and the second subsystem 4 may, in practice, be placed in different geographic locations, and may be operated by different entities. In an embodiment, the first subsystem 2 is operated by the 3D part manufacturer, whereas the second subsystem 4 is operated by a security assessment operator or by a security certification authority.

The first subsystem 2 comprises a 3D part computer-aided manufacturing system 6, which comprises a manufacturing machine, for example, in an embodiment, a 3D printer, which receives input manufacturing data 8.

Printing material 9 is also provided as an input to the manufacturing system 6.

The input manufacturing data 8 comprises several data sets:
data 8A relative to the shape of the 3D part, for example a CAD file comprising the part's 3D model;
data 8B relative to the required printing material and its required characteristics,
data 8C relative to the manufacturing parameters, typically recorded in a Computer-Aided Manufacturing file (CAM).

Finally, input manufacturing data 8 comprises the applicable regulatory constraints.

The input manufacturing data is typically dependent on the manufacturing process, for example additive or subtractive, and the type of manufacturing devices.

Furthermore, data 8D is collected by sensors during the manufacturing itself, for example with respect to each layer in an additive manufacturing process. Such data 8D includes operation and environment parameters, respectively, for example, laser and scanning parameters (laser average and peak powers, frequency or polarization, or scan strategy or velocity, for example), and build environment parameters (ambient temperature, pressure, hygrometry, and oxygen level, for example). Data 8D also may comprise sensor captured photos/videos during manufacturing.

In an embodiment, each of these data sets 8A, 8B, 8C, 8D is recorded, for example in files, at a dedicated network address.

According to an alternative embodiment, the data sets 8A, 8B, 8C, 8D are jointly memorized and can be accessed at a unique network address.

According to an embodiment, one or several of the data sets 8A, 8B, 8C, 8D is compressed and further stored in a compressed format.

Preferably, data sets 8A, 8B, 8C, 8D are memorized on a non-transitory storage device readable by a processing system, for example a non-transitory storage of a server system, such as a random access memory (RAM), read only memory (ROM), remote access hardware drive (conventional hard drive or cloud storage) accessible through direct connection, wired or wireless or a combination thereof.

Preferably, the data sets 8A, 8B, 8C, 8D are stored either in a centralized or a distributed storage, such as a centralized or distributed database, or a block-chain enabled ledger.

The pedigree data is formed by at least part of input manufacturing data 8A, 8B, 8C, 8D.

In an embodiment, pedigree data comprises all data sets 8A, 8B, 8C, 8D.

In the embodiments described hereafter, pedigree data comprises at least part of data set 8D.

A pedigree data indication 10 is provided to a mark computation module 18 that will be described in detail hereafter.

The pedigree data indication 10 is either an indication, such as a network address, allowing to access the pedigree data, or the pedigree data itself, in compressed or uncompressed format, or a combination of a part of the pedigree data and one or several network addresses allowing to access the rest of the pedigree data.

A 3D part 12 is either fully manufactured and output by the manufacturing system 6, or partially manufactured and its manufacturing is suspended by the manufacturing system 6 during the mark computation, the manufacturing being finalized, and the mark insertion performed, jointly after the mark computation.

A unique identifier computation module 14 computes a unique identifier (UID) 16 of the 3D part 12.

In a preferred embodiment, the unique identifier computation module 14 computes a physically unclonable function (abbreviated as PUF) of the 3D part 12. The unique identifier 16 is either the obtained PUF value of the 3D part 12 or is calculated on the basis of the obtained PUF value of the 3D part 12.

Advantageously, the unique identifier 16 is intrinsically linked to the 3D part 12.

Any known method for computing a PUF may be used, but its substance isn't part of the present invention's object. For example, the physically unclonable function of the 3D part is a random physical characteristic of the 3D part inherent in a random physical characteristic of the material, or at least one material, constituting it, such as the orientation of electromagnetic particles or the distribution of chemical molecules detectable by spectrometry. Advantageously, the physically unclonable function value is unpredictable, so specific, to each manufactured 3D part, and is different for any two 3D parts, even though they are serially manufactured using the same input manufacturing data and the same manufacturing conditions. Therefore, the manufacturer is unable to manufacture a second part with same PUF value as a given first part, that is to clone the first part.

The unique identifier computation module 14 comprises a device adapted to compute the chosen physically unclonable function, for example a scanner or a spectrometer.

According to an embodiment, in the context of additive manufacturing or injection molding, the manufacturing is modified to introduce a physically unclonable function. For example, when a first printing material is used, a second printing material is added, the second printing material having mechanical properties analoguous to the mechanical properties of the first printing material, but possessing a random physical characteristic.

According to another variant, a semiconductor material is inserted into the 3D part, and the physically unclonable function is computed based on the conductivity of the inserted semiconductor material, for example based on the thermal motion or on impurities of the semiconductor material, which are random characteristics, so that said conductivity itself is.

The UID 16 is cryptographically combined with the pedigree data indication 10 by the mark computation module 18, to obtain a pedigree information, which is then encoded in a mark 20 to be inserted in the 3D part.

For example, the pedigree data indication 10 is encrypted with a predetermined secret key encryption algorithm, the unique identifier UID being used as the secret key.

The mark 20 is either the result of the encryption or a piece of information encoding the result of the encryption.

For example, the mark 20 is an alphanumeric string, a QR-code or a barcode encoding the result of the cryptographic combination of the pedigree data indication 10 and of the UID.

The mark 20, when decoded and resulting pedigree information cryptographically recombined, gives access to the 3D part's pedigree data indication 10, and therefore access to the pedigree data itself is provided.

Advantageously, the mark 20 is unique for each 3D part since it is computed based on the 3D part's PUF value, so the marked 3D part 24 is unclonable, and therefore the mark 20 provides non-tamperable anchoring of its pedigree data within the marked 3D part 24. Non-tamperable access to the pedigree is thus given on the basis of the sole marked 3D part 24.

According to an embodiment, the mark computation module 18 is in the form of program code that can be executed by one or several processors of an electronic computing device. In an alternative the mark computation module 18 is made in the form of a programmable logic component, such as an FPGA (Field Programmable Gate Array), or in the form of a dedicated integrated circuit, such as an ASIC (Applications Specific Integrated Circuit).

The mark 20 obtained is inserted in surface or inside a volume of the 3D part by the mark insertion module 22. Finally, a marked 3D part 24 is obtained.

For example, when the mark 20 is a QR-code or a barcode, the mark is printed, as a whole or piece by piece, on an external surface or an internal layer of the 3D part. The printing on an internal layer achieves inserting the mark within a volume of the 3D part.

In an alternative embodiment of the subsystem 2, the modules 14, 18 and 22 are integrated within the manufacturing system 6.

According to another alternative, the modules 14, 18 and 22 are integrated in a same device (not represented) connected to the printer 6.

The marked 3D parts obtained using the first subsystem 2 may be used in various operation contexts.

A marked 3D part 30 is processed for mark reading by the second subsystem 4.

The second subsystem 4 comprises a unique identifier computation module 32, which is analoguous to the unique identifier computation module 14 already described.

The unique identifier computation module 32 computes the UID of the marked 3D part 30, for example by computing a physically unclonable function of the marked 3D part 30. The unique identifier (UID) 34 is either the obtained PUF value of the marked 3D part 30, or is calculated based upon the obtained PUF value of the marked 3D part 30. The physically unclonable function computed is the same as the physically unclonable function computed by the unique identifier computation module 14 of the first subsystem 2 for a given 3D part, and the UID is calculated based upon the obtained PUF value in the same way as it has been by the unique identifier computation module 14 of the first subsystem 2. Therefore, the obtained PUF and UID values are equal to those obtained by the unique identifier computation module 14 of the first subsystem 2, provided that the marked 3D part 30 has not been significantly altered.

Furthermore, the second subsystem 4 comprises a mark reading module 36, which is configured to read the mark inserted by the mark insertion module 22 of the first subsystem 1, and decode the read mark to obtain the pedigree information encoded by the mark. For example, in the case the mark is a QR-code, the mark reading module 36 comprises a scanner and image processing tools to obtain the encoded pedigree information from the QR-code.

Therefore, the read mark and obtained pedigree information values are equal respectively to those inserted by the mark insertion module 22 and computed by the mark computation module 18 of the first subsystem 2, provided that the marked 3D part 30 has not been significantly altered.

The pedigree information and the UID 34 are provided to a computation module 40 configured to extract a pedigree data indication, giving access to pedigree data 42 by cryptographically recombining the UID 34 and the pedigree information encoded by mark 38. As in the first subsystem 2, the pedigree data indication is either the pedigree data itself, or an indication, such as a network address, of the pedigree data stored.

The cryptographic recombination is linked to the cryptographic combination applied by the mark computation module 18 of the first subsystem. For example the cryptographic recombination consists in applying decryption with the UID as the secret key, the decryption algorithm corresponding to the encryption algorithm applied by the mark computation module 18.

Therefore, the extracted pedigree data indication is equal to that provided to the mark computation module 18 of the first subsystem 2, provided that the marked 3D part 30 has not been significantly altered.

In an embodiment, the computation module 40 delivers as an output one or several network addresses of pedigree data 42. Finally, one or several data sets 42A, 42B, 42C, 42D of pedigree data, corresponding respectively to the data sets 8A, 8B, 8C, 8D described above, are retrieved.

In an embodiment, all data sets 42A, 42B, 42C and 42D are retrieved, comprising input manufacturing data and manufacturing data collected during the manufacturing process itself.

Retrieved data sets among 42A, 42B, 42C and 42D are equal to homologous data sets among 8A, 8B, 8C and 8D, provided the marked 3D part 30 has not been significantly altered. In the contrary, retrieved data sets are unusable as such and the processing is interrupted.

According to an embodiment, the modules 32, 36 and 40 are integrated within a same device.

The pedigree data 42 obtained is provided to a system 3 for detecting manufacturing breaches.

In an embodiment, subsystem 3 comprises a module 45 configured to generate classifying means for manufacturing process breach detection by applying an artificial intelligence machine learning algorithm, as described in more detail hereafter.

In an embodiment, the classifying means are stored in an electronic memory 46.

A module 48 is configured to apply the classifying means to the pedigree data retrieved from a marked 3D part, then to decide whether a manufacturing process breach detection has occurred.

The classifying means allow to label the pedigree with an identifier of a pedigree class among a predetermined set of pedigree classes. The predetermined set of pedigree classes comprises a class of non breached (that is showing no manufacturing process breach) pedigrees and at least one class of breached (that is showing a manufacturing process breach) pedigrees. At least two breached pedigree classes may be defined, to distinguish breached pedigrees for example depending on the type of the manufacturing process breaches they show. To the end of the classification, the marked 3D part's pedigree data may be compared to stored parameters forming the descriptions of the classes of the predetermined set of pedigree classes.

For example, the pedigree data may show that the 3D part 30 was manufactured in an environment having a temperature below a nominal temperature threshold, and it may be known that such a low temperature may result from a given type of attack against the manufacturing process.

In an embodiment, an alarm may be raised by an alarm raising module 50.

In another embodiment, at least one additional 3D part the manufacturing of which was similarly breached, may be retrieved.

As a complement, security assessment, assurance and/or improvement is achieved.

Preferably, the detecting of manufacturing breaches is implemented in the form of program code that can be executed by one or several processors of an electronic computing device. In an alternative, the detecting of manufacturing breaches is made in the form of a programmable logic component, such as an FPGA (Field Programmable Gate Array), or in the form of a dedicated integrated circuit, such as an ASIC (Applications Specific Integrated Circuit).

FIG. 2 is a block diagram of the main steps of an embodiment of a method for manufacturing a 3D part, carried out by the first subsystem 2 of a manufacturing and manufacturing process breach detection system.

This method comprises a supplementary stage, formed by steps 52 to 64 described hereafter, which is applied during the manufacturing of the 3D part or after the 3D part has been manufactured.

A computation 52 of a unique identifier (UID) of the 3D part is applied. For example, a physically unclonable function (PUF) of the 3D part is computed. Any known method for computing a PUF may be applied.

The UID of the 3D part is either the value of the PUF, or is computed from the value of the PUF, for example by applying a predetermined cryptographic function, such as a hash function or an encryption function, to the PUF value.

According to an alternative embodiment, a unique identifier of the 3D part is obtained by incrementing a serial number or by generating a random value.

Next, pedigree data is received at reception step 54, the pedigree data comprising various data sets relative to the input manufacturing data and to the actual manufacturing conditions of the 3D part.

For example, as already mentioned above, the pedigree data comprises data 8D collected during the manufacturing and may further comprise data 8A relative to the shape of the 3D part, and/or data 8B relative to the printing material and its required material characteristics, and/or data 8C relative to the manufacturing parameters.

The pedigree data may be received either in the form of the data sets themselves, or in the form of one or several addresses allowing to access the data sets. Alternatively, the pedigree data may be received piece by piece, either in the form of a pedigree data subset, or in the form of one or several addresses allowing access the pedigree data subset.

In an embodiment, at least one subset of the pedigree data is compressed at compression step 56 by any known mean for this purpose, and the resulting digest is stored in association with the pedigree data subset.

Finally, a pedigree data indication is obtained at step 58. The indication may be in the form of a bitstream or in the form of a string of characters, for example indicating a network address.

If several network addresses are provided for the data sets forming the pedigree data, these network addresses are for example concatenated (or aggregated) into a string of characters.

The unique identifier and the pedigree data indication are provided to a cryptographic combination step 60, in order to compute pedigree information.

For example, a secret-key based symmetric encryption algorithm is applied, to encrypt the pedigree data indication using the UID as secret key. For example the algorithm AES (Advanced Encryption Standard) is applied.

Next a mark to be inserted on or within a volume of the 3D part is computed (step 62) from the pedigree information.

For example, a QR-code, which is a matrix of black and white pixels encoding the pedigree information is computed.

The mark is next inserted into the 3D part at marking step 64. For example, the mark, in the form of a QR-code, is printed on an external surface of the 3D part.

According to an alternative, the mark is printed on an internal surface or within an internal volume of the 3D part, and therefore computed before the manufacturing of the 3D part is completely achieved. In this alternative, the 3D part's manufacturing is finished, and the printing of the mark on an internal surface or within an internal volume of the 3D part performed, after the mark has been computed.

FIG. 3 is a block diagram of the main steps of a method of manufacturing process breach detection based on pedigree data.

The method comprises obtaining a request to examine a marked 3D part (step 70), for example a marked 3D part which presents a failure, or the operation context of which presents a failure.

We call operation context of a 3D part in operation, a system in operation of which the 3D part is a subsystem. For example an aircraft may be considered the operation context of one of its wings, of a high-lift flap of this wing, or of a rivet of this high-lift flap.

As an aircraft wing may be considered the operation context of one of his high-lift flaps, or of a rivet of this high-lift flap.

Next, a mark reading step 72 is applied. The mark, previously inserted on a surface or within a volume of the marked 3D part is read by appropriate means, for example by an optical reading device, such as a scanner for reading a QR-code image.

The mark is decoded in decoding step 74, to obtain the pedigree information associated with the marked 3D part.

Furthermore, a unique identifier (UID) of the marked 3D part is computed at step 76, for example by computing a physically unclonable function (PUF) of the marked 3D part.

Analogously to step 52 already described, the UID of the marked 3D part is either the value of the PUF, or is computed from the PUF value, for example by applying a predetermined cryptographic function, such as a hash function, to the PUF value.

The UID and the pedigree information associated with the marked 3D part are provided as an input to step 78 for computing a pedigree data indication by cryptographic recombination.

The cryptographic recombination corresponds to the cryptographic combination applied at step 60 previously described. For example, a secret-key based symmetric decryption algorithm is applied, to decrypt the pedigree data indication using the UID as secret key. For example the algorithm AES (Advanced Encryption Standard) is applied.

The pedigree data indication is then processed in step 80 to obtain the pedigree data itself. If the pedigree data is compressed, a corresponding decompression is applied.

If the pedigree indication has been obtained by concatenating (or aggregating) pedigree data sets or network addresses for the pedigree data sets, a corresponding de-concatenation (or de-aggregation) is applied.

If the pedigree data indication is a network address, the corresponding data set(s) is (are) obtained. According to an alternative embodiment, the pedigree data indication represents the pedigree data itself, and step 80 is skipped.

Finally, the pedigree data associated with the marked 3D part is obtained, provided that the mark read is actually the one affixed or inserted during the manufacturing stage, and that the computed UID of the 3D part is the same as the one computed during the manufacturing.

Next, the pedigree data is processed at processing step 82, to achieve manufacturing process breach detection.

The manufacturing process breach detection comprises, in an embodiment, applying a classifier to classify the retrieved pedigree in one of several predetermined classes, and deciding, based on the result of the classification, whether a manufacturing process breach occurred during the manufacturing of the examined marked 3D part. The classifier and the predetermined classes 84 are generated in a previous analysis step, and are subsequently memorized. The previous analysis step applies either a supervised or an unsupervised approach, as described in further detail hereafter.

The manufacturing process breach detection is followed, in an embodiment, by raising a security alarm (step 86), which may comprise sending the security alarm to the marked 3D part's manufacturer and/or the customer for which he manufactured the marked 3D part.

In an embodiment, after the detection of a manufacturing process breach based on a given marked 3D part's pedigree, a step 88 of identifying at least one additional marked 3D part having a similarly breached manufacturing process is implemented.

The at least one additional marked 3D part's pedigree is retrieved as being classified in the same class as the given marked 3D part's pedigree. Then an identifier of the additional marked 3D part is retrieved as being stored in association with its pedigree.

Therefore the additional marked 3D part itself may be obtained, for example through a manufacturer's or his customer's database, or any other type of data storage, allowing to localize the additional marked 3D part in operation. Then, the non-tamperable anchoring into the additional marked 3D part of its pedigree may be exploited, in steps analogous to steps 72 to 80, in order to securely retrieve its pedigree. Then this retrieved pedigree is compared with the additional marked 3D part's pedigree to securely verify it actually is the same, or not. If the comparison is successful, that is if both pedigrees are the same, the additional marked part is more securely identified as having the additional marked 3D part's pedigree than originally as corresponding to the latter, thanks to the usage of the non-tamperable anchoring into it of its pedigree.

FIG. 4 is a block diagram of the main steps of a method of generating classifying means according to an embodiment.

In this embodiment, a large number of 3D part pedigrees is provided as an input called training data set.

This embodiment implies a large number of calculations, and is preferably implemented using a plurality of processors, for example organized according to a distributed computing system or a cloud computing system.

A label is associated with some or all of the 3D parts pedigrees of the training data set (step 90)

If the expected class of each of the pedigrees of the training data set is known and also provided as an input to the generating classifying means method, then each of the pedigrees of the training data set is labeled with an identifier of its expected class.

If the expected class of some of the pedigrees of the training data set is known and also provided as an input to the generating classifying means method, then each of the concerned pedigrees of the training data set is labeled with an identifier of its expected class.

If the expected class of each of the pedigrees of the training data set is not known, then classes of the pedigrees of the training data set are first determined using any artificial intelligence non-supervised method such for example as anomaly detection or clustering methods.

In order to determine classes of the pedigrees of the training data set, an artificial intelligence (AI) anomaly detection algorithm is applied (step 92) to identify outliers among the pedigrees of the training data set. For example, this anomaly detection algorithm are chosen among: Local Outlier Factor, Isolation Forest, One-class Support Vector Machine, or any other outliers detecting algorithms including usage of clustering algorithms such as Hierarchical clustering and Density-Based Spatial Clustering of Applications with Noise to detect outliers.

A score of the extent of anomaly of each outlier is computed (step 94), for example based on an anomaly score produced by the anomaly detection algorithm as in the case of Isolation Forest, or by comparing the distances of the outliers and inliers from the center of mass of the inliers, or any other mean of evaluating the extent of the anomaly identified.

The outliers and the inliers are then classified according to any type of classification algorithms including Deep Neural Networks, Convolutional Neural Networks, Random Forest, Extreem Gradient Boosting, Naïve Bayes, Support Vector Machines, Logistic Regression (step 96).

Each of the pedigrees of the training data set is stored (step 98), in association with the label corresponding to its classification.

In all cases, finally, a machine learning algorithm is trained with the training data set to obtain a classifying means also known as a classifier. A list of parameter values characterizing classes of pedigrees are output and stored (step 100), the parameters list depending on the chosen classification algorithm, and forming classifying means to be applied to marked three-dimensional parts pedigrees for detecting breaches in their manufacturing processes.

1. A method for manufacturing a three-dimensional part by a computer-aided manufacturing process, the three-dimensional part being manufactured by a manufacturing system based on input manufacturing data comprising a model of the three-dimensional part, input manufacturing data related to a required material and its required characteristics, and input parameters relative to the manufacturing system, the method comprising:
computing pedigree information relating to the manufacturing process of the three-dimensional part, wherein the pedigree information gives access to pedigree data of the three-dimensional part, the pedigree data comprising manufacturing data collected during the manufacturing process of the three-dimensional part; and
inserting a mark encoding the pedigree information on a surface or within a volume of the three-dimensional part, to obtain a marked three-dimensional part.

2. The method according to claim 1, wherein the pedigree data further comprises input manufacturing data of the three-dimensional part.

3. The method according to claim 1, wherein the computing of pedigree information comprises:
computing a unique identifier of the three-dimensional part;
obtaining a pedigree data indication comprising the pedigree data of the three-dimensional part or providing access to a storage address of the pedigree data of the three-dimensional part; and
applying a cryptographic combination of said unique identifier and said pedigree data indication to obtain the pedigree information.

4. The method according to claim 3, wherein the step of computing a unique identifier of the three-dimensional part comprises computing a physically unclonable function of the three-dimensional part.

5. The method according to claim 4, wherein the step of computing a unique identifier further comprises applying a cryptographic function to the physically unclonable function of the three-dimensional part.

6. The method according to claim 3, wherein applying a cryptographic combination of said unique identifier and said pedigree data indication comprises applying a secret key cryptographic function to the pedigree data indication, wherein the used secret key is said unique identifier.

7. The method according to claim 1, wherein the inserting of a mark is achieved by printing said mark, as a whole or piece by piece, on a surface or within an internal volume of the three-dimensional part.

8. A method for detecting a manufacturing process breach in a computer-aided manufacturing process of a marked three-dimensional part, the marked three-dimensional part being manufactured according to a computer-aided manufacturing process, the marked three-dimensional part being manufactured by a manufacturing system based on input manufacturing data comprising a model of the three-dimensional part, input manufacturing data related to a required material and its required characteristics, and input parameters relative to the manufacturing system, the method comprising:
generating classifying means for manufacturing process breach detection;
retrieving the marked three-dimensional part's pedigree data, the retrieval comprising:
reading a mark of the marked three-dimensional part, the mark encoding pedigree information, wherein the pedigree information gives access to pedigree data of the marked three-dimensional part, the pedigree data comprising manufacturing data collected during the manufacturing process of the marked three-dimensional part; and
retrieving the pedigree data of the marked three-dimensional part using said pedigree information; and
determining whether a manufacturing process breach of the marked three-dimensional part's manufacturing process occurred, by applying the classifying means to the retrieved pedigree data.

9. The method according to claim 8, wherein the retrieving of the pedigree data comprises:
computing a unique identifier of the marked three-dimensional part;
applying a cryptographic recombination of said unique identifier and said pedigree information to obtain a pedigree data indication associated to the marked three-dimensional part; and
obtaining pedigree data of the marked three-dimensional part from the pedigree data indication.

10. The method according to claim 9, wherein the cryptographic recombination of said unique identifier and said pedigree information comprises applying a secret key cryptographic function to the pedigree information, wherein the secret key is said unique identifier.

11. The method according to claim 8, wherein generating classifying means for manufacturing process breach detection comprises applying to a plurality of pedigrees forming a training data set:
labeling each of the pedigrees of the plurality of pedigrees forming the training data set with an identifier of its expected class;
training a machine learning algorithm with the training data set to obtain a classifying means, comprising a list of parameter values characterizing classes of pedigrees, and to be applied to three-dimensional marked parts pedigrees for detecting breaches in the manufacturing processes of said three-dimensional marked parts pedigrees; and
storing the obtained classifying means.

12. The method according to claim 11, wherein the labeling of each pedigree of the plurality of pedigrees forming the training data set comprises:
applying, to the plurality of pedigrees forming the training data set, an anomaly detection artificial intelligence algorithm to identify outliers and inliers among the plurality of pedigrees forming the training data set;
computing a score of anomaly extent associated to each of the identified outliers and inliers; and
classifying each pedigree of the plurality of pedigrees forming the training data set into classes based on its score of anomaly extent.

13. The method according to claim 8, further comprising raising an alarm in case of manufacturing process breach detection.

14. The method according to claim 13, further comprising, in case of manufacturing process breach detection:
retrieving an additional pedigree within the same class as that of the retrieved pedigree data;
identifying an additional marked three-dimensional part the pedigree of which is the retrieved additional pedigree; and
securely verifying the additional pedigree data actually is the additional marked three-dimensional part's pedigree data, comprising retrieving its pedigree data from the additional marked three-dimensional part.

15. A system for manufacturing a three-dimensional part according to a computer-aided manufacturing process, the three-dimensional part being manufactured by a manufacturing system based on input manufacturing data comprising a model of the three-dimensional part, input manufacturing data related to a required material and its required characteristics, and input parameters relative to the manufacturing system, the system comprising:
a module configured to compute pedigree information relating to the three-dimensional part, wherein the pedigree information gives access to pedigree data of the three-dimensional part, the pedigree data comprising manufacturing data collected during the manufacturing process of the three-dimensional part; and
a module configured to insert a mark encoding the pedigree information on a surface or within a volume of the three-dimensional part, to obtain a marked three-dimensional part.

16. A system for detecting a manufacturing process breach in a computer-aided manufacturing process of a marked three-dimensional part, the marked three-dimensional part being manufactured according to a computer-aided manufacturing process, the marked three-dimensional part being manufactured by a manufacturing system based on input manufacturing data comprising a model of the three-dimensional part, input manufacturing data related to a required material and its required characteristics, and input parameters relative to the manufacturing system, comprising at least one processor configured to implement:
a module configured to generate classifying means for manufacturing process breach detection;
modules configured to retrieve the marked three-dimensional part's pedigree data, the retrieval comprising:
reading a mark of the marked three-dimensional part, the mark encoding pedigree information, wherein the pedigree information gives access to pedigree data of the marked three-dimensional part, the pedigree data comprising manufacturing data collected during the manufacturing process of the marked three-dimensional part; and
retrieving the pedigree data of the marked three-dimensional part using said pedigree information; and
a module configured to determine, whether a manufacturing process breach of the marked three dimensional part's manufacturing process occurred, by applying the classifying means to the retrieved pedigree data.
